(19) United States
(12) Patent Application Publication
(10) Pub. No.: US 2006/0120795 A1
(43) Pub. Date: Jun. 8, 2006

(54) Glitter marker

(76) Inventor: Kevin Martzloff, Malibu, CA (US)

Correspondence Address: LAW OFFICE OF RICHARD B. KLAR, 28 East Old Country Road, Hicksville, NY, 11801, US

(21) Appl. No.: 10/725,184

(22) Filed: Nov. 29, 2003

(51) Int. Cl. B43K 5/18

(52) U.S. Cl. 401/235

(57) ABSTRACT

A glitter marking instrument such as a marker, highlighter and the like, is provided which includes a barrel having a front portion. A liquid mixture of ink and glitter is stored within the barrel. The glitter marking instrument further comprises a nib for receiving the ink/glitter mixture to effectuate a writing on a chosen surface. The nib is housed partially within the front portion of the barrel and a portion of the nib protrudes outwardly from within the front portion of the barrel. Further, the nib has an outer surface and the nib is axially movable within the front end of the barrel. Moreover, when the nib of the marking instrument has sufficient pressure exerted upon it to move said nib axially inward further within the front portion of the barrel then the ink/glitter mixture stored within the barrel is caused to flow to the nib. The ink portion of the ink/glitter mixture saturates said nib, but the glitter portion of the ink/glitter mixture is not absorbable by said nib, and thus the glitter portion of the ink/glitter mixture goes around the outer surface of said nib instead to create a decorative glitter effect around said outer surface of said nib.

### BACKGROUND OF THE INVENTION

1. Field of the Invention

The present invention relates to decorative marking instruments such as decorative magic markers and highlighters and the like. In particular, the present invention relates to decorative marking instruments wherein an ink/glitter liquid mixture stored within the barrel of the instrument is supplied to the nib of the instrument, but the glitter portion of the ink/glitter liquid mixture is not absorbable by the nib, so the glitter goes around the outer surface of the nib instead to creative a decorative glitter effect.

2. The Prior Art

Marking instruments are known in the prior art. For instance, U.S. Pat. No. 6,224,284 B 1 relates in relevant part to metallic ink based writing instruments and more particularly to metallic ink compositions for wick type writing instruments. U.S. Pat. No. 6,209,548 B1 relates in relevant part to a method and apparatus for applying nail paint. In a preferred embodiment, a pen-like applicator which comprises a barrel wherein nail paint is contained and a nib that is configured for applying nail paint to a nail. Further, U.S. Pat. No. 6,027,274 relates in relevant part to a marking instrument which includes a reservoir chamber for marking fluid, a channel for conducting marking fluid from the reservoir chamber for supply to a marking tip, and a valve for controlling the supply of fluid through the channel. The valve includes a seat member with a port, a diaphragm having an edge for cooperation with the seat member to close the port, and a free surface extending from the edge to a position at which the diaphragm is held against movement. The seat member is movable to deflect the diaphragm for opening the valve. Moreover, U.S. Pat. No. 5,888,007 relates in relevant part a marking instrument, such as a reservoir pen, having a valve for controlling communication between a reservoir chamber and a feed channel extending through a feed member to a marking tip. The feed member is retractable to open the valve when the tip is pressed against a surface. A subchamber is confined by a diaphragm sealingly connected between the feed member and the barrel, and when the marking tip is lifted from the surface, the diaphragm pushes the feed member forwardly so that the valve closes, after which the volume of the subchamber increases so that the ink is drawn through the channel from the tip.

Finally, U.S. Pat. No. 5,332,326 relates in relevant part a writing instrument such as a felt-tip pen or white board marker in which liquid ink is directly filled in an ink reservoir without using a fibrous material and a slide pug is provided in the pen barrel such that the slide valve divides the interior of the pen barrel into an air region and an ink region and moves toward the ink region as the ink is used.

Notwithstanding the above, the prior art lacks markers or highlighters which provide glitter around the outer surface of the nib of the instrument upon each use of the instrument to provide a unique decorative effect around the nib.

### SUMMARY OF THE INVENTION

It is therefore a principle object of the invention to provide a marking instrument having a liquid mixture of glitter and ink stored within the barrel of the instrument, some of which is supplied to the nib of the instrument upon contact with a writing surface, but wherein the glitter portion of the ink/glitter mixture is not absorbable by the nib but instead goes around the outer surface of the nib to create a decorative glitter effect around the outer surface of the nib.

In accordance with the present invention, a glitter marking instrument such as a marker, highlighter and the like, is provided which includes a barrel having a front portion. A liquid mixture of ink and glitter is stored within the barrel. The glitter marking instrument further comprises a nib for receiving the ink/glitter mixture to effectuate a writing on a chosen surface. The nib is housed partially within the front portion of the barrel and a portion of the nib protrudes outwardly from within the front portion of the barrel. Further, the nib has an outer surface and the nib is axially movable within the front end of the barrel. Moreover, when the nib of the marking instrument has sufficient pressure exerted upon it to move said nib axially inward further within the front portion of the barrel then the ink/glitter mixture stored within the barrel is caused to flow to the nib. The ink portion of the ink/glitter mixture saturates said nib, but the glitter portion of the ink/glitter mixture is not absorbable by said nib, and thus the glitter portion of the ink/glitter mixture goes around the outer surface of said nib instead to create a decorative glitter effect around said outer surface of said nib.

The glitter marking instrument preferably further includes an ink/glitter control assembly for regulating the supply of said ink/glitter mixture stored within the barrel to the nib. The ink/glitter control assembly is located within the barrel between the storage area for the ink/glitter mixture and the nib. Moreover, when the marking instrument is not in use, the ink/glitter control assembly acts as barrier to the flow of ink/glitter mixture from its storage area within the barrel to the nib. The ink/glitter control assembly is operatively connected to the nib such that when a sufficient pressure is applied to the nib, the nib retracts axially inward further within the front portion of the barrel to cause the displacement of the ink/glitter control assembly upward, creating an open passageway between the storage area for the ink/glitter mixture and the nib, thereby allowing the ink/glitter mixture to flow from the storage area through the passageway to the nib.

### BRIEF DESCRIPTION OF THE DRAWINGS

FIG. 1 is a perspective view of the marking instrument of the present invention FIG. 2 is a perspective view of the marking instrument in FIG. 1 with the marking instrument cap removed;

FIG. 3 is a cross-sectional view of the marking instrument of FIG. 2;

FIG. 4 is a cross-sectional view of the marking instrument of FIG. 2 not in use or at rest;

FIG. 5 is a cross-sectional view of the marking instrument of FIG. 2 in use on a writing surface; and

FIG. 6 is a fragmentary view of the marking instrument of FIG. 1.

### DETAILED DESCRIPTION OF PREFERRED EMBODIMENTS

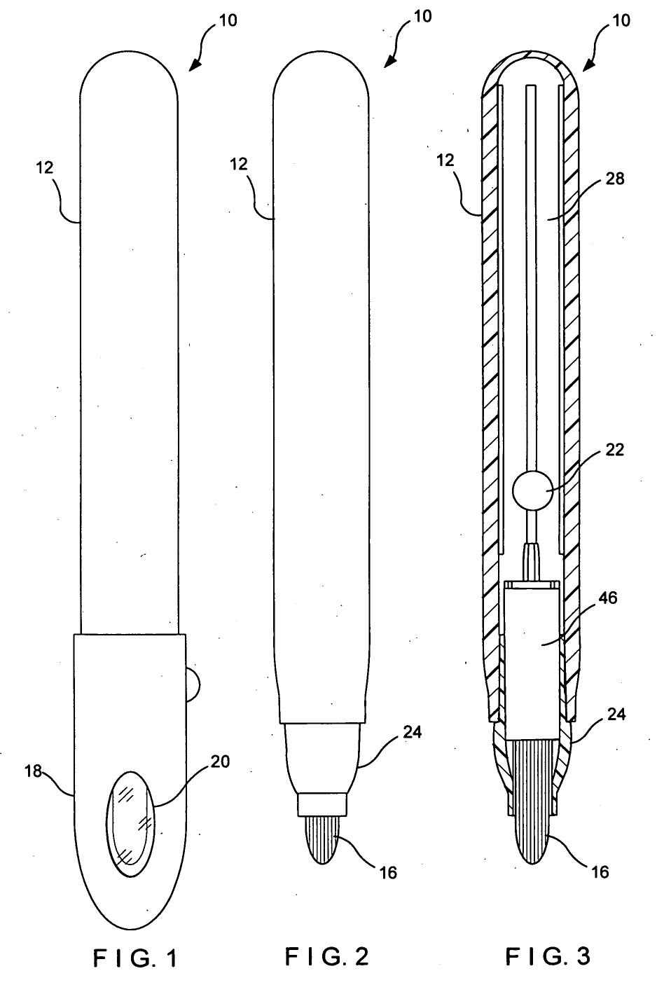

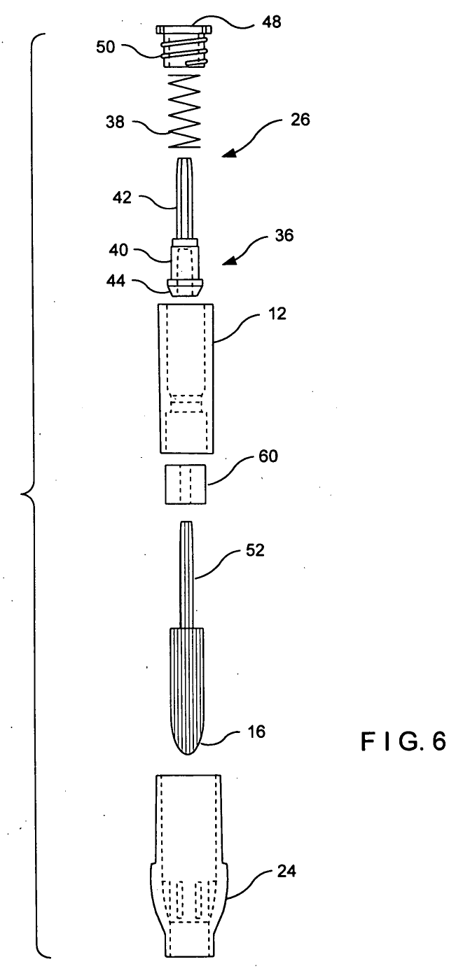

Referring to a preferred embodiment of the present invention, depicted in FIGS. 1-6, a glitter marker is referred to generally at 10. However, it is noted that the present invention is not limited to markers but also encompasses such writing instruments as highlighters and any other writing instrument which would work in the same manner as described herein.

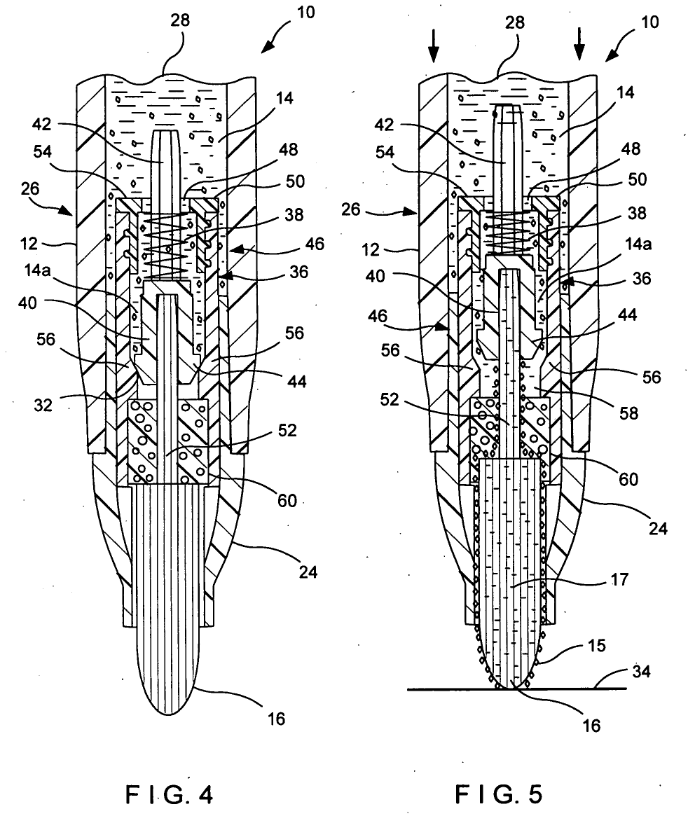

As illustrated in FIGS. 1-6, the marker 10 includes a barrel 12, an ink/glitter mixture 14 (specifically illustrated in FIGS. 4 and 5) and a writing tip or nib 16. In the preferred embodiment of the present invention of FIG. 1, it is depicted that the marker also includes an end cap 18 which is removably attached to the front end of the barrel 12 to cover the nib 16 to prevent the ink on said nib from drying upon exposure to the atmosphere. The end cap 18 as shown in FIG. 1 may also be provided with one or more windows 20 in an exterior side wall of the end cap 18 for a user to able view into the marker 10 and see the nib 16. Moreover, as shown in FIG. 3, preferably at least one mixing ball 22, preferably composed of stainless steel, is contained within the barrel 12 of the marker 10 to assist in effectively mixing the ink/glitter mixture 14.

Referring to FIGS. 1-5, the barrel 12 of the marker 10 is preferably made of a transparent plastic material, wherein the ink/glitter mixture 14 may be viewed. Also the exterior surface of the barrel 12 and the exterior surface of the end cap 18 may each be designed with decorative glitter thereon to enhance the decorative effect of the marker 10. Barrel 12 further includes a nose portion 24, preferably cone shaped, housed partially within its front end. The nib 16 is axially movable within the nose portion 24 of the barrel 12. Further, the nib 16 is preferably of tubular shape as shown in FIGS. 2-5. However, the shape of the nib 16 may be any shape used for conventional markers, highlighters and the like.

As shown in FIGS. 3-6, the marker 10 preferably further includes an ink/glitter control assembly 26 for regulating the flow of ink/glitter mixture 14 stored in ink/glitter supply reservoir 28 within the barrel 12 to the nib 16. Reservoir 28 is the space defined within the barrel 12 between ink/glitter control assembly 26 and the distal end 30 of the interior of the barrel 12. Ink/glitter control assembly 26 regulates the flow of ink/glitter mixture 14 from the reservoir 26 to the nib 16 by forming a seal or barrier 32 between reservoir 28 and the nib 16. The barrier 32 opens and closes depending on whether or not the marker 10 is being used. Namely, when the marker 10 is in use (FIG. 5), as is the case when the nib 16 of the marker 10 presses against a writing surface 34 (e.g. paper) to effectuate a writing (e.g. letters or words), the barrier 32 opens to allow the ink/glitter mixture 14a to flow through to the nib 16. Alternatively, when the marker is not being used (FIG. 4), the barrier 32 remains closed so as to prevent the ink/glitter mixture 14a from flowing to the nib 16.

As illustrated in FIGS. 4-6, ink/glitter supply assembly 26 includes a valve member 36 and a spring 38. Valve member 36 has a central body portion 40, a thin tubular rear end 42 and a dome shaped front portion 44. Mounted on the tubular rear end 42 of the valve member 36 is spring 38 and the spring 38 urges against the central body 40 of the valve member 36. The entire ink/glitter control assembly 26 is housed within the ink/glitter control assembly housing 46, with the exception of a portion of the tubular rear end 42 of the valve member 36 which protrudes outwardly through an opening 48 provided in top cover 50. Top cover 50 encloses the upper portion of the ink/glitter control assembly housing 46. As shown in FIG. 3, the ink/glitter control housing 46 is preferably a tubular shaped housing. Also, as indicated in FIGS. 3-5, a portion of the ink supply housing 46 itself is housed within the nose portion 24 of the barrel 12.

Turning to how the ink supply assembly 26 regulates the flow of ink/glitter mixture 14 to the nib 16 of the marker 10, this regulation is achieved by way of a cooperative relationship between the ink/glitter supply assembly 26 and the nib 16. Namely, as best illustrated in FIGS. 4-6, ink/glitter control assembly 26 is operatively connected to the nib 16 via an elongated rod member 52 attached to the rear end of the nib 16. The rod member 52 extends upward from the nib 16, wherein its upper portion is housed within valve member 36 via an opening 54 in the dome shaped front portion 44 of the valve member 36. The rod member 52 is slidable axially in response to axial movement of the nib 16. When the marker 10 is at rest or otherwise not is use as depicted in FIG. 4, the ink/glitter mixture 14 is barred from reaching or making contact with the nib 16 by the ink/glitter control assembly 26. In particular, some of the ink/mixture 14 stored in ink supply reservoir 28 flows from the reservoir through the top cover 50 of the ink/supply assembly housing 46 via opening 54 and into the ink/control assembly housing 46. However, the ink/glitter mixture 14a in the ink/glitter control assembly housing is prevented from flowing out of the ink supply assembly housing 46 and into contact with the nib 16 due to the barrier 32 formed by domed shaped front portion 44 of the valve member 36 of the ink/glitter control assembly 26.

Specifically, the outer periphery of the front portion 44 of the valve member 36, when the marker is not in use, lockingly engages with the side walls 56 of the ink/glitter supply assembly housing 46 to form barrier 32 to prevent the flow of ink/glitter mixture 14a from out of the tubular housing 46 to the nib 16. The outer periphery of the front portion 44 of the valve member 36 is held or maintained in engagement with the side walls 56 of the ink/glitter control assembly 26 with the assistance of spring 38. Spring 38 (i.e. uncoiled at rest) which is mounted on the rear end of the valve member 44, urges against the central body portion 40 of valve member 44 to exert a downward pressure against the front portion 44 of the valve member 36 to maintain the outer periphery of the front portion 44 of the valve member 36 in sealing or locking engagement with the walls 56 of the ink/glitter assembly housing 46, thereby preventing ink/glitter 14a from flowing out of the ink/glitter assembly housing 46 and into contact with the nib 16.

Conversely, when the marker 10 is being used, as depicted in FIG. 5, e.g. when the nib 16 is pressed against a writing surface 34 in order to effectuate a writing, the nib 16 retracts inward moving further into the interior of the nose portion 24 of the barrel 12. The retraction of the nib 16 inward exerts an upward pressure on valve member 36 via the rod member 52. Valve member 36 in turn exerts an upward pressure on spring 38 to compress or coil the spring 38. Once the spring 38 is compressed with sufficient pressure, the valve member 36 moves upward dislodging the domed shaped front portion 44 of the valve member 36 from engagement with the walls 56 of the tubular ink/glitter control assembly housing 46, thereby creating an open channel 58 within the tubular ink/glitter housing 46 for the ink/glitter mixture 14a in the tubular housing to flow through. The glitter/ink mixture 14a flows through open channel 58 and into the interior of the nose portion 24 of the barrel 12 to the nib 16. The ink portion 17 of the ink/glitter mixture 14a saturates the nib 16, but the glitter portion 15 of the mixture is not absorbable by the nib 16 so it goes around the outer surface of the nib 16 to create a decorative glitter effect around the outer surface of the nib. Finally, as shown in FIGS. 4 and 5, a sponge 60 is preferably mounted on the lower portion of the rod member 52, adjacent or integral with the nib 16, to absorb any excess ink/glitter mixture 14a traveling to the nib 16, in order to prevent the marker from dripping any ink/glitter 14a.

In using the marker 10 (FIG. 5) of the present invention, the user would first shake the marker 10 to mix the ink/glitter solution 14. The user would then press the marker 10 against a writing surface 34 to put letters, symbol, words, designs, etc. onto the writing surface 34. Once the nib 16 of the marker 10 is pressed against the writing surface 34, the nib 16 slides axially inward further into the interior of the nose portion 24 of the barrel 12 to cause an upward pressure to be exerted on the valve member 36 of the ink/glitter supply assembly 26, which in turn causes an upward pressure to be exerted onto the spring 38. When the upward pressure on the spring 38 is sufficient to compress the spring 38, the valve member 36 moves upward, thereby disengaging or dislodging outer periphery of the domed shaped front portion 44 of the valve member 36 from the walls 56 of the ink/glitter supply housing 46, thereby creating an open channel 58 in the tubular ink/glitter assembly housing 46 for ink/glitter mixture 14a to flow through to the nib 16. The ink/glitter mixture flows 14a through open channel 58 and into the interior of the nose portion 24 of the barrel 12 to the nib 16. The ink portion 17 of the ink/glitter mixture 14a saturates the nib 16, but the glitter portion 15 is not absorbable by the nib 16 but instead goes around the outer surface of the nib 16 to create a decorative glitter effect around the outer surface of the nib 16. If more glitter and or a darker ink is desired, the user would keep pressing the nib 16 against the writing surface 34 to allow more ink and glitter to contact the nib 16.

When the user is done with the marker 10, he or she removes the marker 10 from the writing surface 24, the nib 16 moves back outward to its original position as shown in FIG. 4, the spring 38 uncoils or unwinds, and the outer periphery of the front portion 44 of the valve member 36 returns to its locking engagement with the walls 56 of the ink/glitter control assembly housing 46 to seal the open channel 58. The user may repeat use of the marker 10 as desired, in the manner described above.

The particular embodiment described above is not meant to be exclusive. Many other variations of the present invention would be obvious to those skilled in the art, and are contemplated to be within the scope of the appended claims.

What is claimed is:

1. A glitter marking instrument comprising:
a barrel having a front portion;
a liquid mixture of ink and glitter, said ink/glitter mixture is stored within said barrel;
a nib for receiving said ink/glitter mixture to effectuate a writing on a chosen surface, said nib being housed partially within said front portion of said barrel and a portion of said nib protrudes outwardly from within said front portion of said barrel, said nib is axially movable within said front end of said barrel, said nib having an outer surface; and
wherein when said nib has pressure exerted upon it to move said nib axially inward further within said front portion of said barrel the said ink/glitter mixture stored within said barrel flows to said nib, said ink portion of said ink/glitter mixture saturates said nib, said glitter portion of said ink/glitter mixture is not absorbable by said nib but instead goes around the outer surface of said nib to create a decorative glitter effect around said outer surface of said nib.

2. The glitter marking instrument of claim 1 further comprising an ink/glitter control assembly for regulating the supply of said ink/glitter mixture stored within said barrel to said nib, said ink/glitter control assembly is located within said barrel between said storage area for said ink/glitter mixture and said nib, said ink supply assembly acts as barrier to the flow of ink/glitter mixture from its storage area within said barrel to said nib when said marking instrument is not in use, said ink control assembly system is operatively connected to said nib such that when a sufficient pressure is applied to said nib said nib retracts axially inward further within said front portion of the barrel to cause displacement of said ink/glitter control assembly upward, creating an open passageway between said storage area for said ink/glitter mixture and said nib, thereby allowing said ink/glitter mixture to flow from said storage area through said passageway to said nib.

3. The glitter marking instrument of claim 1, further comprising an end cap removably attached over said front portion of said barrel to cover said nib when the marking instrument is not in use.

4. The glitter marking instrument of claim 3, wherein said barrel and said end cap are each composed of plastic material.

5. The glitter marking instrument of claim 3, wherein said end cap has at least one viewing window in an exterior side wall of said end cap for a user to able view into the marker and see the nib of the marking instrument.

6. The glitter marking instrument of claim 3, wherein an exterior surface of said barrel and an exterior surface of said end cap each have decorative glitter designed thereon.

7. The glitter marking instrument of claim 1, wherein said glitter marking instrument is a glitter magic marker.

8. The glitter marking instrument of claim 1, wherein said nib is tubular shaped.

9. The glitter marking instrument of claim 1, wherein said nib is composed of felt material.

10. The glitter marking instrument of claim 1, wherein the said ink portion of said ink/glitter mixture is of the color selected from the group consisting of red, green and purple.

11. The glitter marking instrument of claim 1, wherein said color of said glitter marking instrument is selected from the group consisting of red, green and purple.

12. The glitter marking instrument of claim 1, further comprising at least one mixing ball located within said barrel to assist in the mixing of the ink/glitter mixture.

13. A glitter marking instrument comprising:
a barrel having a front end;
a cone shaped nose portion housed partially within said front end of said barrel;
a reservoir for storing a liquid mixture of ink and glitter, said reservoir is located in said barrel;
a nib housed partially within said cone shaped nose portion of said front end of said barrel and a portion of said nib protrudes outwardly from within cone shaped nose portion, said nib is axially movable within said cone shaped nose portion, said nib having an outer surface;
an ink/glitter control assembly for regulating the supply of said ink/glitter mixture from said reservoir to said nib, said ink/glitter assembly acts as a barrier to the flow of said mixture to said nib when said marking instrument is not in use, said ink/glitter supply assembly comprises a valve member and a spring, said valve member has a central body portion, a thin tubular rear end and a dome shaped front end, said spring is mounted on said tubular rear end of said valve and said spring urges against said body of said valve member;
an elongated rod member attached to a rear end of said nib, said elongated member extends upward from said nib with an upper portion of said elongated member being housed within said valve member through an opening in said dome shaped front end of said valve member, said rod member is slidable axially within said barrel in response to axial movement of said nib;
a tubular ink/glitter control assembly housing having an upper portion, a lower portion and top cover, said top cover covers said upper portion of said tubular housing, said ink/glitter control assembly housing houses said ink/glitter assembly in its entirety, with the exception of a portion of said tubular rear end of said valve member which protrudes outwardly from said ink/supply housing through an opening provided in said top cover of said assembly housing, when said nib is not being pressed against a writing surface then an outer periphery of said domed shaped front portion of said valve member of said ink/glitter control assembly engages with side walls of tubular ink/glitter control assembly housing forming a barrier to prevent the ink/glitter control assembly housing from flowing out through the ink/glitter control assembly housing into the front nose portion of the barrel to reach the nib, said spring exerts a downward pressure on said valve member to maintain the outer periphery of said domed shaped front portion of valve member in locking engagement with said side walls of the ink/glitter control assembly housing; and
whereby when said nib of said marking instrument is pressed against a writing surface to effectuate a writing said nib moves axially inward further into the interior of the front nose portion of the barrel to cause said elongated rod member to exert an upward pressure on the valve member of the ink/glitter control assembly, which in turn causes an upward pressure onto said spring sufficient to compress said spring causing the valve member to move upward dislodging the domed shaped front portion of the valve member from engagement with said walls of said ink/glitter control housing and thereby creating an open channel within said ink/glitter assembly housing, said ink/glitter mixture flows through said open channel in said ink/glitter control assembly housing and into the interior of the front nose portion to the nib, said ink portion of said ink/glitter mixture saturates said nib, said glitter portion of said ink/glitter mixture is not absorbable by said nib but instead goes around the outer surface of said nib to create a decorative glitter effect around said outer surface of said nib.

14. The glitter marking instrument of claim 13, further comprising a sponge mounted on a lower portion of said rod member, adjacent said nib, to absorb any excess of said ink/glitter mixture traveling to said nib, in order to prevent the marker from dripping any excess ink/glitter.

15. The glitter marking instrument of claim 13, wherein a portion of the ink supply housing is housed within said front nose portion of said barrel.

16. The glitter marking instrument of claim 13, further comprising an end cap removably attached over said cone shaped nose portion of said barrel to cover said nib when the marking instrument is not in use.

17. The glitter marking instrument of claim 13 further comprising at least one steel mixing ball located within said barrel to assist in the mixing of the ink/glitter mixture.

18. The glitter marking instrument of claim 13, wherein said glitter marking instrument is a glitter magic marker.

19. The glitter marking instrument of claim 13, wherein said nib is made of felt material.

20. A method for creating a decorative glitter effect around the nib of a marking instrument, comprising:
shaking said marking instrument, wherein said marking instrument comprises a barrel having a front portion, a liquid mixture of ink and glitter, said ink/glitter mixture is stored within said barrel, a nib housed partially within said front portion of said barrel and a portion of said nib protrudes outwardly from within said front portion of said barrel, said nib is axially movable within said front end of said barrel aid, said nib having an outer surface;
pressing said nib against a writing surface drawing some of said ink/glitter mixture stored within said barrel of said marking instrument in contact with said nib, said glitter portion of said ink/glitter mixture is not absorbable by said nib so it goes around the goes around the outer surface of said nib to create a decorative glitter effect around said outer surface of said nib; and
removing said nib from said writing surface when finished using said marking instrument.
